(19) United States
(12) Patent Application Publication
(10) Pub. No.: US 2026/0253076 A1
(43) Pub. Date: Aug. 27, 2026

(54) NETWORKED SYSTEM FOR PRIVATE ASSET MANAGEMENT ACROSS A PUBLIC VERIFICATION LAYER AND A PRIVATE TRANSACTION LAYER

(71) Applicant: Hamsa Pay, Inc., San Francisco, CA (US)

(72) Inventors: Hongbing WU, San Francisco, CA (US); Adam ZBAR, San Francisco, CA (US); Wenhao LIN, San Francisco, CA (US); Huanyu MA, San Francisco, CA (US)

(21) Appl. No.: 19/178,295

(22) Filed: Apr. 14, 2025

Related U.S. Application Data
(60) Provisional application No. 63/764,505, filed on Feb. 27, 2025.

(51) Int. Cl. G06Q 20/40; H04L 9/00; H04L 9/32

(52) U.S. Cl. CPC G06Q 20/401; H04L 9/3221; H04L 9/50

(57) ABSTRACT

A system has a public verification layer including public blockchain transaction machines in network communication. A private transaction layer includes transaction machines in network communication, configured to utilize zero-knowledge proofs (ZKPs) to record private transactions as encrypted data, inaccessible to entities not involved in the transactions. At least one transaction machine groups private transactions into a verification job. The verification job is processed by the public blockchain transaction machines to generate validity proofs-of-state for each private transaction. Final state changes are returned to the transaction machines for recordation.

### CROSS-REFERENCE TO RELATED APPLICATION

This application claims priority to U.S. Provisional Patent Application 63/764,505, filed Feb. 27, 2025, the contents of which are incorporated herein by reference.

### FIELD OF THE INVENTION

This invention relates generally to authorizing transactions in computer networks. More particularly, the invention is directed to a networked system for private asset management across a public verification layer and a private transaction layer.

### BACKGROUND OF THE INVENTION

A distributed ledger (also referred to as a blockchain) is a decentralized collection of machines that operate in a public manner to record transactions permanently and incorruptibly. Machines implementing the distributed ledger are commonly referred to as “on chain” machines since they operate on a blockchain. On-chain transactions within a distributed ledger are growing in popularity. While users appreciate the attributes of a distributed ledger, there is a need to execute transactions without all the transaction details available to the public. In other words, there is a need for a networked system for private asset management across on chain and off chain machines.

### SUMMARY

A system has a public verification layer including public blockchain transaction machines in network communication. A private transaction layer includes transaction machines in network communication, configured to utilize zero-knowledge proofs (ZKPs) to record private transactions as encrypted data, inaccessible to entities not involved in the transactions. At least one transaction machine groups private transactions into a verification job. The verification job is processed by the public blockchain transaction machines to generate validity proofs-of-state for each private transaction. Final state changes are returned to the transaction machines for recordation.

A 2-layer blockchain architecture is used to enable secure, private, and scalable financial transactions. It integrates a private Layer 2 (private transaction layer) leveraging Zero-Knowledge Composable Smart Contracts (zk-CSC) for confidential, atomic operations, with a public Layer 1 (public verification layer) for proof verification of zk-rollup transactions.

At the application layer, users interact with a Software Development Kit (SDK) to perform account-related functions. Transactions and balances remain private through zero-knowledge proofs (ZKPs) generated by the Account Service within secure, private infrastructure. ZKPs validate off-chain computations and enable on-chain execution without revealing sensitive data.

At layer 2, standard token protocols (e.g., ERC20, ERC1155) are extended with advanced methods such as balance splitting, merging, and ownership transfer—ensuring that only transacting parties can access transaction details. Zero-Knowledge Composable Smart Contracts (ZK-CSCs) deliver full privacy using zero-knowledge proofs (ZKPs) while remaining fully composable. ZK-CSCs can interpret both plaintext logic (standard smart contracts) and encrypted data. ZK-CSCs guarantee atomicity, privacy, and interoperability. Transactions are aggregated via zk-Rollups and finalized on an Ethereum Virtual Machine (EVM)-compatible Layer 1, enabling efficient, institutional-grade clearing and settlement.

### BRIEF DESCRIPTION OF THE DRAWINGS

The invention is more fully appreciated in connection with the following detailed description taken in conjunction with the accompanying drawings, in which:

FIG. 1A illustrates a system configured in accordance with an embodiment of the invention.

FIG. 1B is a high-level system architecture illustrating different layers in accordance with an embodiment of the invention.

FIG. 2 illustrates detailed components in the layers in accordance with an embodiment of the invention.

FIG. 3 illustrates public verification layer and private transaction layer processing performed in accordance with an embodiment of the invention.

FIG. 4 illustrates token processing performed in accordance with an embodiment of the invention.

FIG. 5 illustrates token and business blocks processing in accordance with an embodiment of the invention.

FIG. 6 illustrates token splitting performed in accordance with an embodiment of the invention.

FIG. 7 illustrates token balance after splitting operations performed in accordance with an embodiment of the invention.

FIG. 8 illustrates batch parallel processing performed in accordance with an embodiment of the invention.

FIG. 9 illustrates the workflow and the interactions between modules for a typical business transaction in accordance with an embodiment of the invention.

Like reference numerals refer to corresponding parts throughout the several views of the drawings.

### DETAILED DESCRIPTION

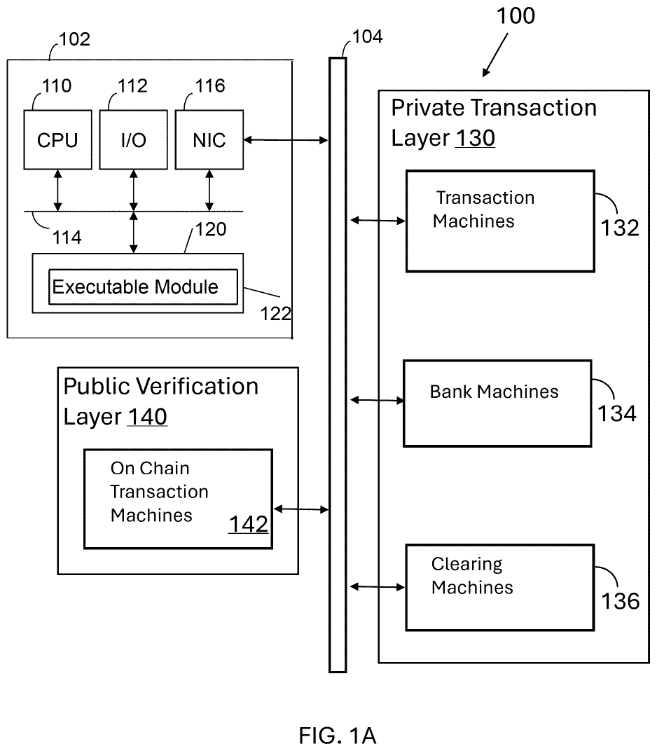

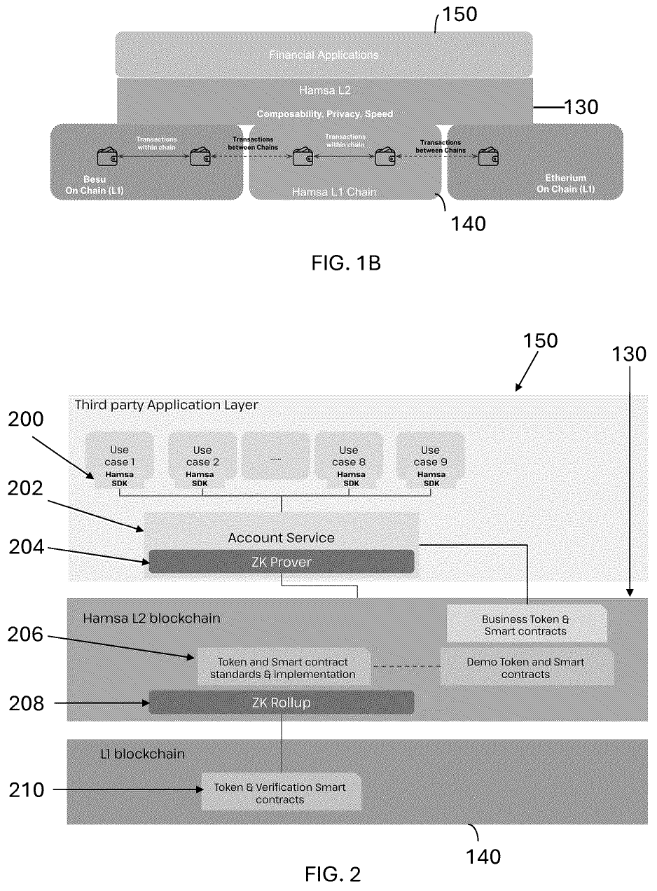

FIG. 1A illustrates a system 100 with a collection of machines to implement operations disclosed herein. Machine 102 is exemplary. Machine 102 has a processor 110 connected to input/output devices 112 via a bus 114. A network interface circuit 116 is also connected to the bus 114 to provide connectivity to network 104, which may be any collection of wired and wireless networks. A memory 120 is also connected to the bus 114. The memory stores an executable module 122 with instructions executed by processor 110 to implement operations specified by the instructions.

System 100 includes a private transaction layer 130, which may include transaction machines 132, bank machines 134 and clearing and settlement machines 136. These machines are distributed cloud resources. The system 100 also includes a public verification layer 140 with on chain transaction machines 142.

The public verification layer 140 has public blockchain transaction machines (on chain transaction machines) 142. The private transaction layer 130 has transaction machines 132, 134, 136 in network communication. The transaction machines utilize zero knowledge proofs to document private transactions as encrypted transaction data private to any entity not involved in the private transactions. At least one transaction machine links private transactions into a verification job. The verification job is processed by the public blockchain transaction machines 142 to establish a validity proof-of-state for each private transaction within the verification job. The public blockchain transaction machines 142 deliver final state changes to the transaction machines for recordation.

FIG. 1B is a high-level characterization of the system of FIG. 1A. Banking and financial applications 150 interact with a two-layer blockchain architecture:

### Layer 1 (L1): Public Verification Layer (140)

Purpose: Serves as a security layer for verifying ZK-rollup proofs submitted from L2.
Type: EVM-compatible public blockchain.
Functionality: Does not execute transactions; it verifies and stores zk-Rollup proofs to confirm transaction validity.
Smart Contract Support: Fully EVM-compatible for easy integration and interoperability.

### Layer 2 (L2): Private Transaction Layer (130)

Purpose: Handles confidential transactions with privacy and scalability.
Type: EVM-compatible blockchain utilizing zk-Rollups and zk-Composable Smart Contracts (zk-CSC).
Features:
   Privacy: Transactions are private using ZKPs, hiding details such as amount and participants.
   Atomicity: zk-CSC ensures atomic swaps and secure operations like DvP (Delivery vs. Payment) and PvP (Payment vs. Payment).
   Composability: Modular smart contracts expose standard APIs and can dynamically link as composable nodes.
   Scalability: zk-Rollups aggregate multiple transactions into a single proof, reducing L1 load and increasing throughput.

### Composability Features

Modular Smart Contracts: Standardized interfaces support chaining and dynamic linking.
Composable Nodes: Contracts form graph structures where outputs feed into subsequent operations.
Cross-Contract Automation: Enables programmable automation across multiple contracts.

### Atomic Transactions

zk-CSC Execution: Ensures atomic transaction execution where all conditions are either met or the transaction reverts.
Use Cases: Enables secure DvP and PvP flows with proof-based validation.

### Privacy Architecture

ZKP Integration: Validates transactions without revealing data.
Pedersen Commitments: Conceals transaction amounts while maintaining verifiability.

### Scalability and Performance

zk-Rollups: Enhance throughput by compressing transaction data into single proofs.
L1 Optimization: Offloads transaction execution to L2, with L1 handling only lightweight proof verification.

### EVM Compatibility

Developer Tooling: Solidity™ support with ZKP-integrated compilers for provable DApp logic.
Bridging: L1-L2 bridges support seamless interaction and cross-chain asset transfers.

### Secure Messaging Layer

Features: Message encryption, signing, and authentication to ensure integrity and prevent spoofing.
Purpose: Facilitates interoperability, proof submission, and cross-chain communication.

FIG. 2 illustrates the detailed system components, showing how banking or financial applications (150) interact with the Layer 2 (L2) blockchain (130), and how L2 communicates with Layer 1 (L1) (140).

### Application Layer (150)

Users interact through an SDK 200, which connects them to the Account Service 202. This service manages user balances and business logic within a secure, private environment. It generates zero-knowledge proofs (ZKPs) 204 to validate operations without revealing sensitive information and sends these proofs to the L2 blockchain 130. The Account Service also handles user-initiated function calls and interacts with smart contracts on L2 to execute business processes.

### L2 Blockchain Layer 130

Transactions are aggregated using zk-Rollups 208 for scalability and privacy. The zk-Rollups are periodically submitted to L1 for validation. The L2 defines enhanced ERC token standards 206, compatible with ERC20, ERC1155, and other EVM standards. These tokens support privacy-preserving methods, including:
Balance Splitting—Splits a token's balance into two parts: transaction amount and remaining balance.
Balance Merging—Combines the balances from two tokens into one.
Token Transfer—Transfers token ownership without revealing the transaction amount, as all balance data is encoded using ZKPs.
   Privacy Features Enabled by ZKPs and above methods:
Confidential Transactions—The transaction amount between User A and User B is invisible to any third party (e.g., User C).
Selective Visibility—Only the transacting parties (User A and User B) can see the transaction amount between them; they cannot view each other's overall wallet balances.

The L2 structure consists of the following primary components:

| Component | Description | Privacy Scope | How it Connects |
|---|---|---|---|
| Private Execution | Individual zk-rollup for | Fully private | Separate local zk- |
| Environments | entities (banks, exchanges, | | ledgers with private |
| (PEEs) | businesses) | | transaction states |
| Inter-Rollup Bridge | Enables private DvP | Private to | Uses zk-CSC to |
| | transactions across | transacting parties | implement DvP, |
| | different PEEs | | etc. transactions. |
| Global zk-Rollup | Bundles thousands of | Aggregated proofs | Syncs private zk- |
| Aggregator | transactions into one proof | (no individual tx | rollups with L1 |
| | before submission to L1 | data) | |
| Layer 1 | Finalizes zk-rollup state | Public (proof only) | Ensures that |
| Commitment Layer | commitments for security | | transactions are |
| | | | valid. |

### L1 Blockchain Layer (140)

The L1 layer contains verification smart contracts 210 that validate zk-proof submitted from L2. It serves as a trustless, public layer to confirm the correctness and integrity of private transactions without accessing sensitive data.

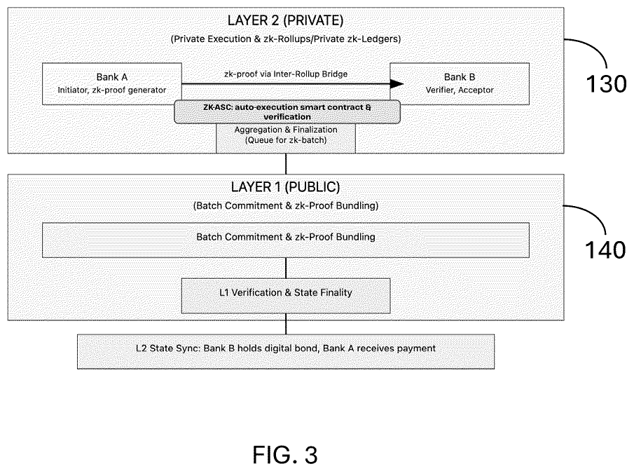

FIG. 3 illustrates public verification layer 140 and private transaction layer 130 processing. The key innovation is the Zero-Knowledge Composable Smart Contracts (ZK-CSC). ZK-CSC combines Zero-Knowledge Proofs (ZKPs) with atomic smart contract execution to ensure privacy, security, and atomicity in decentralized transactions. This enables trustless, confidential, and efficient execution of complex on-chain operations, making them ideal for private financial transactions, Decentralized Finance (DeFi), and institutional clearing and settlement.
Atomic Execution—Ensures all conditions are met before a transaction is finalized (e.g., both payment and asset transfer occur simultaneously).
Zero-Knowledge Privacy—Transaction details (sender, receiver, and amounts) remain confidential while still being verifiable.
Composability—ZK-CSC can interact with multiple smart contracts in a programmable and modular way.
Scalability—By using zk-Rollups, multiple transactions can be bundled into one proof, reducing gas fees and improving throughput.
Decentralization—No need for trusted third parties; smart contracts verify proofs on-chain without exposing sensitive data.

A ZK-CSC framework typically entails the following operations. First, a user submits a transaction. For example, a user signs a smart contract. Next, a Zero-Knowledge proof is generated. This is an off-chain computation that uses a ZK proof to prove that the user has the right to execute the contract and that all conditions (e.g., balance checks, approval) are met. No private data is leaked.

Next, atomic execution and verification is performed on L2. The proof is submitted to the blockchain where a ZK verifier smart contract checks its validity. If valid, the smart contract executes atomically, ensuring that all contract conditions are met, or the transaction is reverted.

The final operation is a final settlement and rollup to L1. L2 transactions are batched and submitted to L1 using zk-Rollups.

The following is a ZK-CSC implementation example.

### a Solidity-Based Smart Contract Integrating ZK:

```
pragma solidity \hat{ }0.8.0;
import “@openzeppelin/contracts/access/Ownable.sol”;
import “@openzeppelin/contracts/utils/cryptography/ECDSA.sol”;
contract ZKAtomicSwap is Ownable {
  using ECDSA for bytes32;
  struct Swap {
    address sender;
    address receiver;
    bytes zkProof;
  }
  mapping(bytes32 => Swap) public swaps;
  function initiateSwap(address receiver, bytes memory zkProof) public {
    bytes32 swapId = keccak256(abi.encodePacked(msg.sender, receiver, zkProof));
    swaps[swapId] = Swap(msg.sender, receiver, zkProof);
  }
  function validateAndCompleteSwap(bytes32 swapId, bytes memory zkProof) public {
    Swap memory swap = swaps[swapId];
    require(keccak256(abi.encodePacked(swap.zkProof)) ==
  keccak256(abi.encodePacked(zkProof)), “Invalid proof”);
    // Transfer funds and complete swap logic here
  }
}
```

To ensure Zero-Knowledge Composable Smart Contracts (ZK-CSC) run efficiently, it is essential to establish Private Execution Environments (PEEs) specifically designed for ZK-CSC. These environments are built using a combination of advanced cryptographic techniques, optimized computation strategies, and scalable smart contract architectures. The high performance of PEEs is achieved through:

### 1. Efficient ZK for Proof Generation

The proving time for ZK circuits can be a bottleneck. To optimize performance:
Precompiled Circuits-Instead of generating proofs from scratch each time, we reuse pre-verified circuit templates for common operations. Layered Computation Offloading
Batch Transactions with zk-Rollups-Instead of verifying every transaction individually, aggregate multiple transactions into a single proof before submitting to Layer 1.
Recursive Proof Composition-Combine multiple ZK into a single proof to reduce verification cost.

### 3. Optimized Smart Contract Execution

Minimized Circuit Complexity-Avoid unnecessary computations inside the ZK circuit, only proving with minimal required data.
Efficient Commitment Schemes-Use Pedersen or Poseidon hashes for commitment generation, as they are optimized for ZK proofs.

The following data structure may be used for tokens on-chain.

```
Struct tokenInfo( ) {
  Uint256 token_id
  Address owner
  Address tokenScAddress
  Uint256 token_type
  Uint256 value
  Enum status //inactive, active, locked, dead
  Bytes[ ] proof
}
```

To support composability, we have defined extended token standards that build upon existing EVM-compatible standards such as ERC-20.

### New Methods Added

In addition to the functions already provided by these standards, our token model introduces the following new methods:

### Token_Proof (Address TokenScAddress, Address Account, Amount)

This asynchronous method generates a proof for spending a token on the public ledger. Internally, it invokes token_split to create a new token matching the requested amount. The returned tokenInfo includes plain text attributes (e.g., value) and a zero-knowledge proof that authorizes spending the token.

token_split (tokenInfo, [smallTokenInfos])

Splits a high-value token into multiple smaller tokens. This function is restricted to execution by bank accounting nodes.

token_merge ([smallTokenInfos], tokenInfo)

Merges multiple small-value tokens into a single token. This operation is also limited to bank accounting nodes.

token_mint (tokenInfo)

Creates a new token, such as a receipt token. Bank accounting nodes invoke this method by calling the public APIs of token smart contracts deployed on the public ledger.

In the invention, all token transactions occur on a public ledger, whose state is synchronized across nodes using a consensus algorithm. This approach enhances security and trust while reducing the need for complex proof generation.

To ensure privacy, all balances on the public ledger are encrypted. Spending from these balances requires generating zero-knowledge proofs (ZKPs). Since proof generation depends on plaintext balance data, this information is maintained off-chain in private accounting tables.

In accordance with blockchain consensus principles, nodes that do not have access to plaintext balances must still be able to verify spending requests. This is achieved by validating the ZKP-based proofs on-chain.

To preserve transaction privacy, the invention replaces traditional balance-based transfers with a new approach:

token_transfer (to, tokenInfo)

This method transfers token ownership to the recipient without revealing any transaction amount. Because balances are encrypted and verified using zero-knowledge proofs, no sensitive information is exposed during the transfer process.

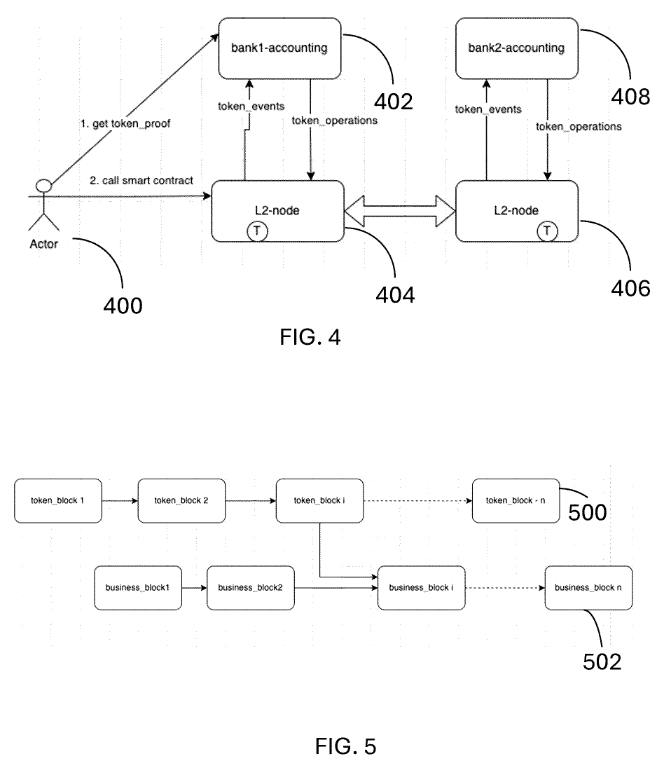

FIG. 4 depicts the interaction flow between actor machines, bank machines, and Layer 2 (L2) node machines in a 2-layer blockchain architecture for secure token operations.

An actor 400 operates an actor machine to obtain a token proof from a bank machine 402. This token proof is included in a smart contract, which is sent to an L2 node machine 404. The L2 node interacts with the bank machine 402 to exchange token events and token operations and also communicates with a peer L2 node machine 406. The peer L2 node, in turn, interfaces with another bank machine 408 to continue the exchange of token events and operations.

Although bank machines 402 and 408 are not part of the L2 blockchain, they are essential for system integrity:
They maintain user balances in plaintext (privately).
They generate proofs for token operations recorded on the L2 public ledger.

To spend tokens in the public ledger:
1. A proof must first be generated by the bank machine.
2. Token operations (e.g., merge, split, transfer) are validated on-chain.
3. The L2 blockchain emits events for each token action.
4. All bank accounting nodes subscribe to these events and update internal balances accordingly.

Although balances within bank machines are private and not visible to others, the system maintains integrity and trust:
All token operations are validated by other L2 nodes using the public ledger.
Fraud is prevented, as token holders must provide valid proofs and follow protocol-enforced logic.

Delivery-versus-Payment (DvP) workflow involves multiple parties (i.e., multiple spend requests) in the same transaction. To verify all the spend requests when executing a DvP transaction on all the blockchain nodes is time consuming.

Our approach treats a token on the public blockchain as an object with attributes, with the two most critical being the owner and the encrypted value.

Before a DvP transaction is executed, the required tokens must be prepared. During DvP execution, only the ownership attributes of the tokens are updated-no changes are made to the encrypted values. This significantly enhances the speed and efficiency of the DvP process.

The tokenInfos parameter contains the token IDs and corresponding values required for the transaction. These values, encrypted using zero-knowledge proofs, are already available on the public ledger. As a result, the DvP trigger has access to all necessary data to validate the transaction as part of the business logic.

Once local validation is complete, the application invokes the DvP.Exchange function, which is executed on the public ledger to finalize the token ownership exchange. Function DvP.Exchange ([tokenswap]) return (bool)

The detailed implementation is in the following section of Delivery versus Payment (DvP).

FIG. 5 illustrates the processing of token and business blocks, along with Delivery versus Payment (DvP) execution within the L2 blockchain architecture.

The DvP smart contract deployed on the public ledger validates all zero-knowledge proofs (ZKPs) associated with a batch of token swaps. Once all proofs are successfully verified, token ownership is updated, finalizing the swap.

Since DvP execution only requires updating token ownership and status, it is highly efficient. However, the performance bottleneck lies in the generation and verification of ZKPs for individual token operations such as Split and Merge. To optimize performance:
Token operations (especially Split and Merge) are grouped by token ID.
Batch processing is applied for proof generation and verification.

This optimization leads to the design of two distinct block types within the L2 blockchain, effectively forming two parallel layers, as shown in FIG. 5:
Token Layer 500: Dedicated to token operations and their associated ZKPs.
Business Layer 502: Handles business logic and contract-related transactions.

Token Representation in the Public Ledger:
On a proprietary ledger, tokens can be individually tracked.
On an L1 EVM compatible blockchain, tokens can be organized using Merkle trees to optimize storage efficiency and enable scalable verification.

One of the most groundbreaking features of Zero-Knowledge Composable Smart Contracts (ZK-CSC) is composability—the ability to combine and orchestrate private smart contracts with each other, as well as with public smart contracts, in a seamless and secure manner. This capability unlocks a new paradigm for decentralized applications, allowing developers to preserve privacy without sacrificing interoperability.

Traditionally, privacy-preserving smart contracts operate in silos due to the complexity of maintaining confidentiality across interactions. ZK-CSCs break this barrier by enabling:
Private-to-Private Composability: Two or more private contracts can securely interact without leaking sensitive data, using zero-knowledge proofs to verify correctness.
Private-to-Public Composability: Private contracts can invoke or be invoked by public contracts.

These interactions are orchestrated through well-defined interfaces and proof verifications that maintain trust without exposure.

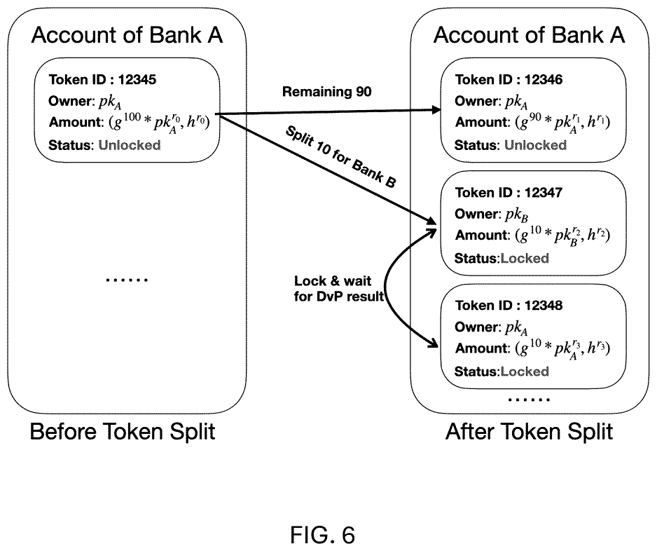

FIG. 6 illustrates how to split a token. The Pedersen Commitment and EC Elgamal Cryptosystem are used for this purpose. The following shows a Pedersen Commitment.
Balance: PC(x1)=g^{x1}h^{r1}+PC(x2)=g^{x2}h^{r2}=PC(x1+x2)=g^{x1+x2}h^{r1+r2}, auxiliary: Envelope (r)=AES256_{key}(r)∥ElGamalpkA(key)∥ElGamal_{pkB}(key)

### ElGamalₚₖ(msg) Encryption:

Assume User has a key pair (sk, pk), where pk=g^{sk},
Let g, h both be random generator of the elliptic curve
Generate random k from [0,q], where q is the order of the elliptic curve.
Calculate C₁=g^{k},
Calculate C₂=pk^{k}·h^{msg},
ElGamalₚₖ(msg)=(C1, C2)
   ElGamalpkA (key) Decryption:
Calculate h^{msg}=C₂-C₁^{sk}=pk^{k}·h^{msg}−g^{k·sk}
Brute force to decrypt msg from h^{msg}, thus msg must not be too big, normally around 32 bits.
The benefit is
   one private balance can be designated with several related parties all of which have the right to get plaintext.=>support censorship.
The drawback is
   for a 256 bit key, ElGamalₚₖ (key) should be a list of 8 ElGamal ciphers each encrypting 32bits of the original key, otherwise ElGamal is not decryptable.

### Proving Logics

Let A be initial amount, B be spending/splitting amount, C be new amount
In PC(B)=g^{B}h^{r}, B is in [0,2 \hat{ }32-1]⇒range proof
In PC(C)=g^{c}h^{r}, C is in [0,2\hat{ }32-1]⇒range proof
ElGamalₚₖ_{ᵢ}(key)=(cipher₀, . . . , cipher₇), where cipherᵢ=(C₁=g^{k}, C₂=pkᵢ^{k}·h^{key}^{ᵢ}) And

$$key = {\sum }_{i = 0}^{7} {key}_{i} * {2}^{32 * i} ⇒ proving decryptable of receiver$$

We make use of the twisted elliptic curve ElGamal cryptosystem to realize balance/transaction amount privacy as well as preserving on-chain balance computability thanks to the homomorphic property of EC ElGamal cryptosystem.

### 1. Public Parameters

Let G be the finite group of all points on the elliptic curve we use, for instance: Secp256k1 or Bn254
Let g and h are two generators of G, g=h^{z} with z unknown.
Let Fₚ be the base prime field.
Let F_{q} be the scalar prime field, where q is the order of G.

### 2. Key Generation

The user randomly selects secret key sk from [0,q), sk⇐F_{q}
The user generates public key pk with h and sk, pk h^{sk}

### 3. Encryption

Randomly select r from [0,q), where q is the order of the elliptic curve.
Calculate C₂=h^{r},
Calculate C₁=g^{x}·pk^{r}
ElGamalₚₖ(x)=(C1, C2)

### 4. Decryption

On receiving an EC ElGamal ciphertext ElGamalₚₖ(x)=(C1, C2)
Calculate g^{x}=C₁−C₂^{sk}=g^{x}·pk^{r}−h^{r·sk}
Brute force to decrypt amount from g, thus x must not be too big, normally around 32 bits.

Attention now turns to L2 on-chain token operations, including token splitting and token merging. Unlike plaintext tokens, transaction order must be maintained for privacy-preserving tokens, as this is crucial to ensure the correctness of state transitions. For an account, the finalized state of a previous transaction must serve as the initial state for the subsequent transaction. This is the only way to accurately prove the balance change. As a result, in a naive approach, the privacy-preserving account model does not support parallel transaction execution.

Token splitting can address this issue. It enables the owner of a privacy-preserving token to divide a large token into several smaller ones, maintaining the total value unchanged. This allows parallel transaction execution, as each smaller token operates independently with its own state.

To illustrate how balance splitting works, we will use an example involving the EC ElGamal representation of tokens.
Originally, the user Alice has a token with amount 100, (g¹⁰⁰·pk_{A}^{r}, h^{r})
When Alice is paying amount 10 to Bob, Alice splits her token into three:
   (1) One with amount 90 for Alice, (g⁹⁰·pk_{A}^{r1}, h^{r1})
   (2) One with amount 10 for Bob, (g¹⁰·pk_{B}^{r2}, h^{r2})
   (3) One with amount 10 for Alice, (g¹⁰·pk_{A}^{r3}, h^{r3})

Note that the 2nd and 3rd token are having the same amount, one of them must be destroyed when DvP finishes, no matter success or failure.
If DvP succeed, token (2) will be transferred to Bob and token (3) will be destroyed
If DvP failed, token (3) will be transferred to Alice and token (2) will be destroyed

Thus, with the disclosed technique, two users in a transaction only see the transaction amount between them. They have no visibility into the remaining funds in the respective digital wallets. Further, the transaction amount between the two users cannot be observed by a subsequent user.
Private inputs: all token amounts.
Public inputs: public parameters, all public keys.
Public output: all ciphertexts.
We need to prove:
   Original token amount=token (1) amount+token (2) amount
   token (2) amount==token (3) amount
   token (1) amount, token (2) amount and token (3) amount all are in [0, 232-1)
   token (1) amount, token (2) amount and token (3) amount all are encrypted using EC ElGamal cryptosystem
   token (2) is encrypted using Bob's public key pk_{B}

With transactions take places, the major token amount will decrease while two types of tokens will accumulate:
(1) Tokens split by the account owner, but DvP not successful.
(2) Tokens sent from others.

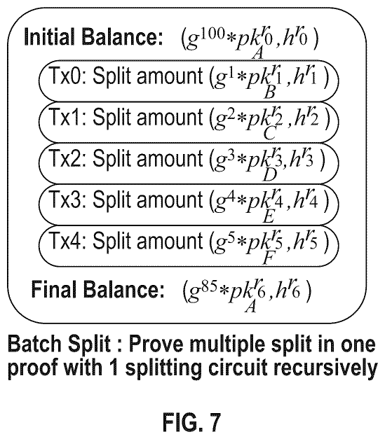

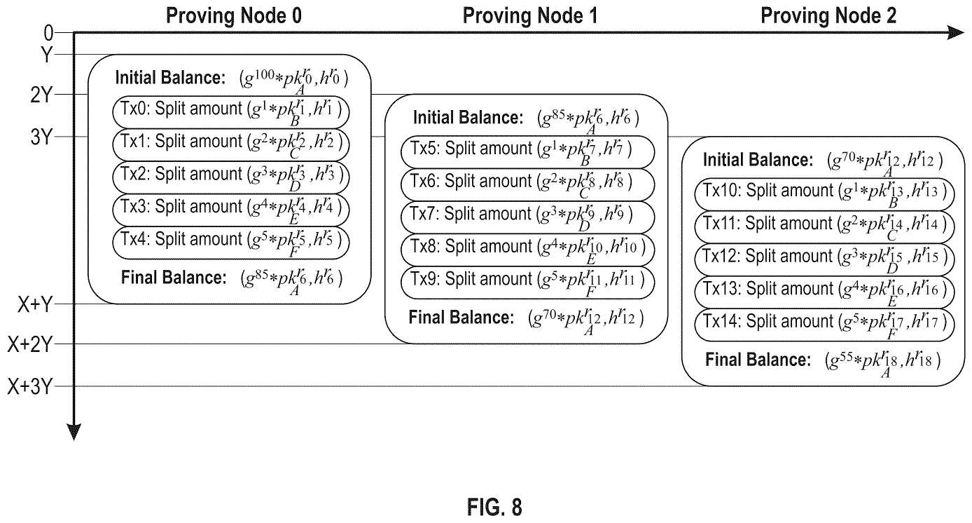

FIGS. 7 and 8 illustrate token splitting performed by a bank and the batch parallel processing.

Since we do not encourage banks to spend multiple tokens in one transaction, which will lead to ZKP generation slowing down. Banks need to merge their coins into one periodically in case transactions with a large amount may take place.

All token amounts are fairly small compared to the 256-bit prime field, so we do not need to worry about amount overflow due to token merging. All banks need to do is to send an instruction of token merging, the smart contract will automatically generate one token maintaining the total amount unchanged.

Using the Nova proof system, we can batch multiple splitting proof generations using one zero knowledge proof. For example,

### Proof (1)

### Original Balance 100

Tx0: split amount=1 to B,
Tx1: split amount=2 to C,
Tx2: split amount=3 to D,
Tx3: split amount=4 to E,
Tx4: split amount=5 to F,

Finalized Balance 85. FIG. 7 illustrates a representation of this transaction.

Actually, we can extend this to a further step, as long as we do not merge tokens, the bank prover can immediately start another ZKP right after the execution of previous proof starts. For example:

### Proof (2)

### Original Balance 85

Tx5: split amount=11 to B,
Tx6: split amount=12 to C,
Tx7: split amount=13 to D,
Tx8: split amount=14 to E,
Tx9: split amount=15 to F,
Finalized Balance 20.

Generation of proof (2) does not need to wait until proof (1) is produced. Since the finality of split tokens and results of DvPs will not affect the major token from decreasing if we do not merge.

The splitting and merging model enhances the scalability of proving time. It allows a batch of split jobs to be provable recursively within a single ZKP as a batched proving job. Additionally, multiple batched proving jobs can be conducted simultaneously, provided the splitting bank has enough nodes. For example, if one batch proving job takes X seconds, the bank will initiate a new batch every Y seconds. As a result, the overall time consumption is shown in FIG. 8.

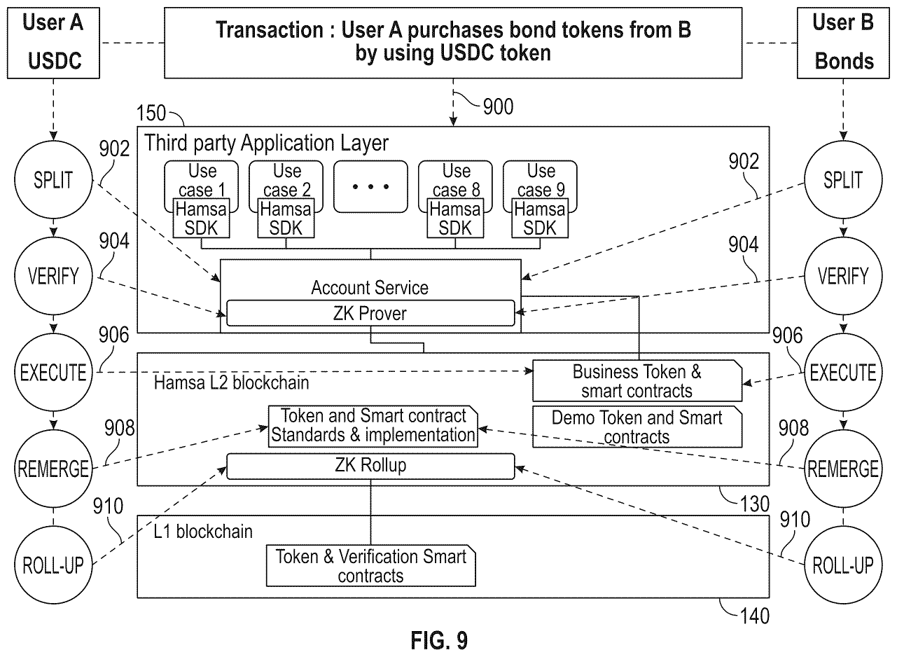

FIG. 9 presents the end-to-end workflow and module interactions for a representative business transaction within the proposed privacy-preserving pipeline.

In this illustrative use case (Use Case 900), a transaction occurs where User A purchases bond tokens from User B using USDC, as defined within the Application Layer 150.

The transaction begins with both users initiating a token split operation via the Account Service, effectively isolating the token balances required for the trade 902. To ensure privacy and integrity, zero-knowledge proofs (ZKPs) are generated and submitted to the Layer 2 (L2) blockchain 904, where they are validated by on-chain verification smart contracts.

Upon successful verification, the ZK-CSC smart contract is triggered to execute the asset exchange in a PEE, securely swapping USDC for bond tokens 906. Following execution, both parties remerge their transactional token balances back into their respective account token balances 908.

To enable scalable throughput with strong privacy guarantees, a zk-rollup mechanism is employed, batching verified L2 transactions and periodically committing them to the Layer 1 (L1) blockchain.

Zero-Knowledge (ZK) technology itself is not new. However, what sets our invention apart is the way we invented zk-CSC with extending the ERC standards, adding splitting, etc, methods, combining ZK proofs with advanced composability and token lifecycle management. Traditional ZK implementations often focus on privacy-preserving computation in isolated contexts-such as confidential transfers. These typically rely on monolithic smart contracts and simple ZK proof-verification.

In contrast, our invention introduces a modular and composable approach:
1. Layer-2 Token Data Encoding: Instead of keeping all token state on Layer 1, we encode token metadata on Layer 2 within a privacy-preserving execution context. This reduces on-chain overhead and allows for faster, cheaper computation.
2. Token Data Splitting Before Transactions: Prior to executing a transaction, token data (e.g., ownership, value, rules) is split into components—some of which remain private, others public—depending on what is required for the transaction.
3. ZK-CSC Verification and Swap Logic: Specialized composable smart contracts—powered by ZK—are used to verify the correctness of the split data and then perform operations like swaps, transfers, or validations without exposing sensitive information.
4. Re-merging Token Data Post-Execution: Once the transaction logic is complete, the token components are recombined to form a unified token state, maintaining full integrity.
5. Roll-up and Commit to Layer 1: Transactions are batched via a ZK roll-up and then committed to Layer 1 for finality, ensuring both scalability and privacy.

This full lifecycle—split→verify→execute→remerge→roll-up—forms a privacy-preserving pipeline that integrates with both private and public smart contracts.

Additionally, we introduce the Privacy Execution Environment (PEE), designed through a combination of advanced cryptographic primitives, optimized computation models, and scalable smart contract architectures. By leveraging the high performance of the PEE environment in conjunction with zk-rollup, the system achieves significantly higher transaction throughput compared to other ZK-based solutions.

1. A system, comprising:
a public verification layer including public blockchain transaction machines in network communication;
a private transaction layer including private transaction machines in network communication, configured to utilize zero-knowledge proofs (ZKPs) to record private transactions as encrypted data, inaccessible to entities not involved in the private transactions;
at least one private transaction machine configured to group private transactions into a verification job of aggregated multiple private transactions;
wherein the verification job is processed by the public blockchain transaction machines to form final state changes with validity proofs-of-state for each private transaction derived as a single proof for the aggregate multiple private transactions, and the final state changes are returned to the private transaction machines for recordation.

2. The system of claim 1, wherein the transaction machines execute zero-knowledge composable smart contracts (zk-CSC) that combine ZKPs with atomic execution to ensure privacy, security, and atomicity in decentralized private transactions, using extended token standards to support splitting, merging, and private transfers.

3. The system of claim 2, wherein the zk-CSCs are interoperable across smart contracts.

4. The system of claim 2, wherein the zk-CSCs are dynamically linked at runtime.

5. The system of claim 2, wherein the zk-CSCs are deployed in a graph structure, with outputs from one node serving as inputs to another.

6. The system of claim 2, wherein zk-CSCs are executed in private execution environments.

7. The system of claim 1, configured for decentralized governance and validation.

8. The system of claim 1, further comprising a messaging layer for encrypted message exchange between machines.

9. The system of claim 1, wherein private transactions are recorded without revealing sender, receiver, or transaction amounts.

10. The system of claim 1, wherein private transactions are executed without revealing wallet balances of transacting parties.

11. The system of claim 1, wherein each private transaction is assigned a unique network address.

12. The system of claim 1, wherein encrypted transaction data incorporates Pedersen commitments to hide transaction amounts while maintaining verifiability.

13. The system of claim 1, further comprising a Decentralized Autonomous Organization (DAO) machine to manage protocol upgrades and governance.

14. The system of claim 1, further comprising a decentralized validator network to confirm ZKPs without accessing transaction data.

15. The system of claim 1, wherein transaction machines perform token operations, including split, merge, and swap.
